(19) United States
(12) Patent Application Publication
(10) Pub. No.: US 2026/0126714 A1
(43) Pub. Date: May 7, 2026

(54) PROJECTION DEVICE AND DRIVING METHOD OF LIGHT SOURCE MODULE SUITABLE FOR PROJECTION DEVICE

(71) Applicant: Coretronic Corporation, Hsin-Chu (TW)

(72) Inventors: Chin-Wen Huang, Hsin-Chu (TW); Yu-Sheng Lee, Hsin-Chu (TW); Wen-Hsin Chang, Hsin-Chu (TW)

(73) Assignee: Coretronic Corporation, Hsin-Chu (TW)

(21) Appl. No.: 19/026,275

(22) Filed: Jan. 16, 2025

Related U.S. Application Data
(60) Provisional application No. 63/715,640, filed on Nov. 4, 2024.

(51) Int. Cl. G03B 21/20; H05B 45/12; H05B 45/20; H05B 47/11; H05B 47/155; H05B 47/16

(52) U.S. Cl. CPC G03B 21/2053; G03B 21/2033; G03B 21/206; H05B 45/12; H05B 45/20; H05B 47/11; H05B 47/155; H05B 47/16

(57) ABSTRACT

A projection device including a light source module, a light source driver module, a light valve module, a lens module, and a control module is provided. The light source driver module drives the light source module to provide the illumination beam of different color lights at different time intervals. The light valve module converts the illumination beam into a projection beam. The control module provides a first control signal to the light source driver module. The light source driver module drives the light source module according to the first control signal. The control module obtains a current value based on a dimming command, and obtains a compensation time period based on the current value. The dimming command indicates that a brightness value of the projected image is adjusted to a target brightness value. The first control signal includes information of the current value and the compensation time period.

### CROSS-REFERENCE TO RELATED APPLICATION

This application claims the priority benefit of U.S. Provisional application Ser. No. 63/715,640, filed on Nov. 4, 2024. The entirety of the above-mentioned patent application is hereby incorporated by reference herein and made a part of this specification.

### BACKGROUND

### Technical Field

The disclosure relates to an optical device and a driving method suitable for the optical device, more specifically, to a projection device and a driving method of a light source module suitable for the projection device.

### Description of Related Art

In DLP (Digital Light Processing) projection technology, the light source module provides different color lights at different time intervals, and the different color lights are converted into image lights in the DMD (Digital Micromirror Device). Therefore, the processor of the projection device controls the lighting time period of different light emitting elements in the light source module through the light source driver module in different time intervals.

However, in some cases, a loss of brightness may occur, and the lighting time period does not match the DMD switching time, so the processor is unable to calculate the brightness of each grayscale correctly, leading to the problem of uneven grayscale.

In addition, when controlling the projection effect of the projection device, the function of reducing the brightness is sometimes achieved by reducing the driving current. If there is no light output for a period in the preset time interval, the uneven grayscale phenomenon may occur under low driving current conditions.

### SUMMARY

An embodiment of the disclosure provides a projection device. The projection device includes a light source module, a light source driver module, a light valve module, a lens module, and a control module. The light source module is configured to provide an illumination beam of different color lights at different time intervals. The light source driver module is coupled to the light source module. The light source driver module is configured to drive the light source module to provide the illumination beam. The light valve module is configured to receive the illumination beam and convert the illumination beam into a projection beam. The lens module is configured to receive the projection beam and project the projection beam out of the projection device to produce a projected image. The control module is coupled to the light source driver module. The control module is configured to generate a first control signal and provide the first control signal to the light source driver module. The light source driver module is configured to drive the light source module according to the first control signal. The control module obtains a current value based on a dimming command, and obtains a compensation time period based on the current value. The dimming command indicates that a brightness value of the projected image is adjusted to a target brightness value. The first control signal includes information of the current value and the compensation time period.

Another embodiment of the disclosure provides a driving method of a light source module suitable for the projection device. The driving method includes: obtaining a current value based on a dimming command, wherein the dimming command indicates that a brightness value of a projected image is adjusted to a target brightness value; obtaining a compensation time period based on the current value; generating a first control signal with information of the current value and the compensation time period; and driving the light source module based on the first control signal at an enable time point to make the light source module provide an illumination beam of a color light after the compensation time period from the enable time point.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram illustrating a projection device according to an embodiment of the disclosure.

FIG. 2 is a waveform diagram illustrating enable signals and a driving current according to an embodiment of the disclosure.

FIG. 3 is a waveform diagram illustrating enable signals and a driving current according to another embodiment of the disclosure.

FIG. 4 is a waveform diagram illustrating enable signals and a driving current according to another embodiment of the disclosure.

FIG. 5 is a schematic diagram illustrating a heavy load mode according to an embodiment of the disclosure.

FIG. 6 is a schematic diagram illustrating a light load mode according to an embodiment of the disclosure.

FIG. 7 is a waveform diagram illustrating enable signals and a driving current according to another embodiment of the disclosure.

FIG. 8 is a schematic diagram illustrating a related curve of the compensation time period and the driving current according to an embodiment of the disclosure.

FIG. 9 is a block diagram illustrating a projection device according to another embodiment of the disclosure.

FIG. 10 is a waveform diagram illustrating enable signals and a driving current according to another embodiment of the disclosure.

FIG. 11 is a waveform diagram illustrating enable signals and a driving current according to another embodiment of the disclosure.

FIG. 12 is a flowchart illustrating steps in a driving method of a light source module suitable for a projection device according to an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides a projection device and a driving method of a light source module suitable for the projection device to dynamically change an enable time based on brightness adjustment. Therefore, the projection device can have smooth grayscale performance when operating at a low driving current.

Other purposes and advantages of the disclosure may be further understood from the technical features recited herein.

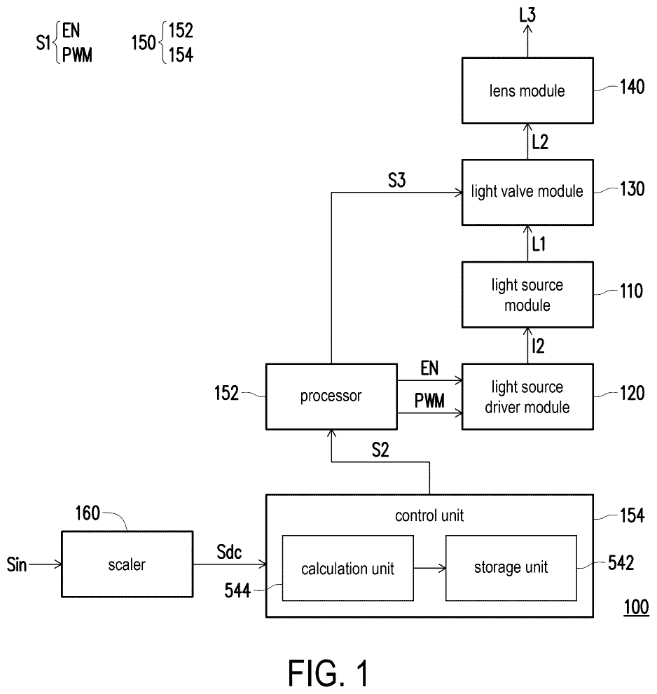

FIG. 1 is a block diagram illustrating a projection device according to an embodiment of the disclosure. The projection device 100 includes a light source module 110, a light source driver module 120, a light valve module 130, a lens module 140, and a control module 150.

In DLP projection technology, the light source module 110 provides different color lights L1 at different time intervals, and the different color lights L1 are converted into image lights L2 in the DMD of the light valve module 130. Therefore, the control module 150 of the projection device 100 controls the lighting time period of different light emitting elements in the light source module 110 through the light source driver module 120 at different time intervals. The time interval refers to the time period that the DMD operates when the light source module 110 provides a color light L1.

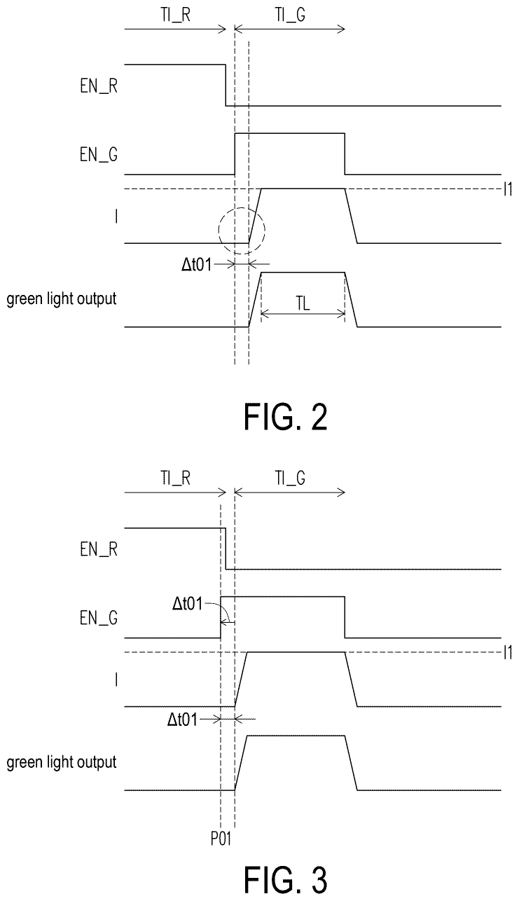

Referring to FIG. 2, taking the green light as an example, when the projection device 100 enters the time interval TI_G of the green light from the time interval TI_R of the red light, the control module 150 outputs an enable signal EN_G to the light source driver module 120. For example, the high level of the enable signal EN_G is outputted to the light source driver module 120, so that the light source driver module 120 drives the light source module 110 to provide the green light.

However, since the light source driver module 120 needs to be charged or discharged, there is a delay time Δt01 before the driving current I is provided to the light source module 110. Therefore, at the beginning of the green time interval TI_G, for the delay time Δt01, the current value of the driving current I is still zero, or the driving current I does not reach the current value I1 that can start the light source module 110. As a result, a loss of brightness may occur, and the lighting time period TL does not match the DMD switching time, so the control module 150 is unable to calculate the brightness of each grayscale correctly, leading to the problem of uneven grayscale.

In addition, as shown in FIG. 3, the enable time point P01 at which the control module 150 outputs the enable signal EN_G is moved earlier by a fixed value, e.g. Δt01, to compensate for the delay time Δt01 caused by the light source driver module 120.

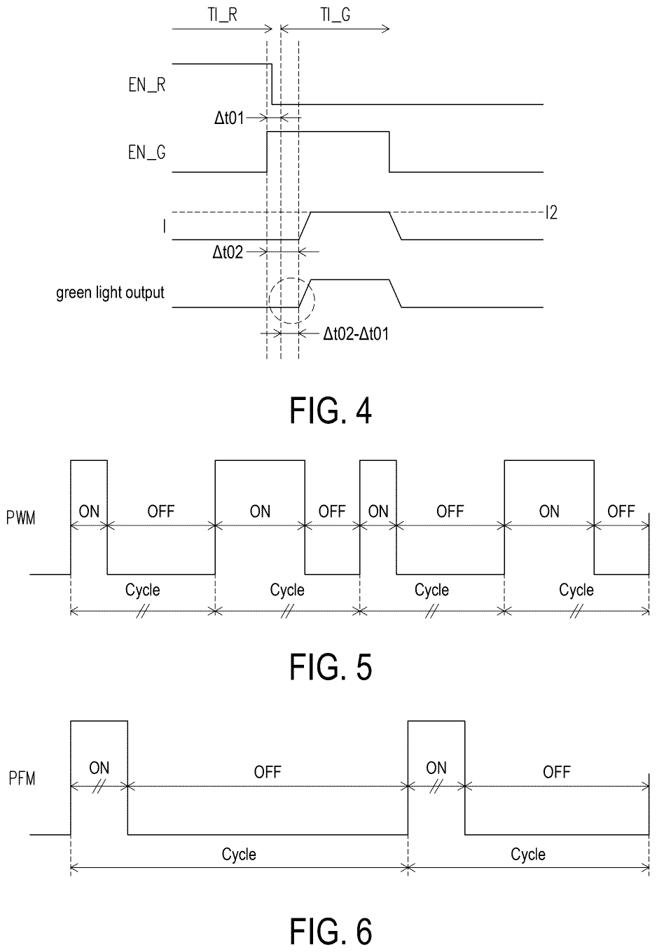

However, when controlling the projection effect of the projection device 100, the function of reducing the brightness is sometimes achieved by reducing the driving current I, for example, the current value is reduced from I1 to I2, and I1>I2. Due to the change of the driving current I, the delay time may be extended from Δt01 to Δt02, as shown in FIG. 4. As a result, if the control module 150 outputs the enable signal EN_G is still moved earlier by the fixed value Δt01, there is no light output for a period of time (i.e. Δt02-Δt01) in the preset green time interval, and thus the uneven grayscale phenomenon occurs under low driving current conditions.

The reason why the delay time becomes longer under low driving current conditions (e.g. current value I2) is that the light source driver module 120 performs voltage chopping and current smoothing through ON/OFF switching to stably provide the driving current I to the light source module 110. However, the ON/OFF switching generates an instantaneous leakage current. In other words, the more ON/OFF switching times per unit time, the greater the loss and the lower the efficiency. Therefore, in order to pursue energy conversion efficiency, the operating modes of the light source driver module 120 are classified into a heavy load mode of FIG. 5 and a light load mode of FIG. 6.

In the heavy load mode, the switching frequency is constant, and the pulse width is adjusted. The switching frequency of the light source driver module 120 is constant, causing the system response speed is constant. Therefore, the delay time is fixed under large driving current conditions.

In the light load mode, the ON time is fixed, and the switching frequency is adjusted by changing the OFF time. Alternatively, the OFF time is fixed, and the switching frequency is adjusted by changing the ON time. In the light load mode, the number of ON/OFF switching times is reduced as the load decreases (i.e. the driving current decreases), and thus losses are also reduced. However, since the switching frequency decreases as the load decreases, the system response also becomes slower, so the delay time becomes longer as the load decreases. Therefore, when the low driving current is used to reduce brightness, there is a problem of uneven grayscale.

In the embodiments of the disclosure, the enable time point at which the control module 150 outputs the enable signal is dynamically adjusted based on the current value provided to the light source module 110.

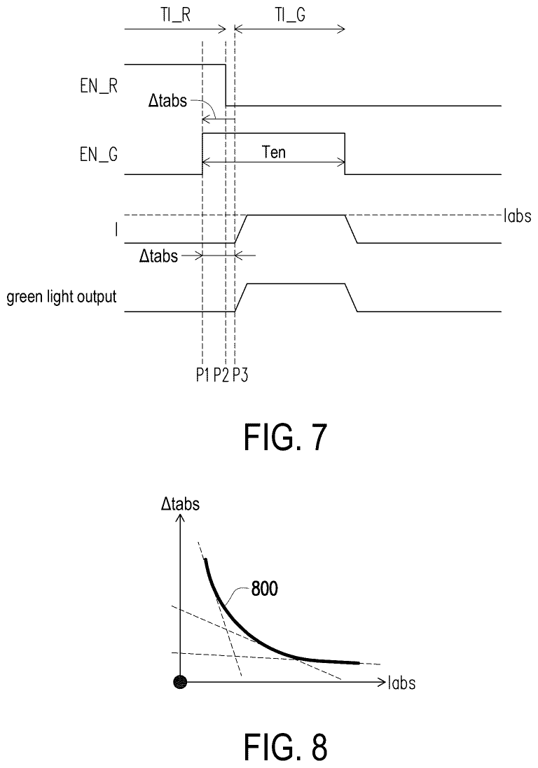

FIG. 7 is a waveform diagram illustrating enable signals and a driving current according to another embodiment of the disclosure. Referring to FIG. 1 and FIG. 7, the light source module 110 is configured to provide an illumination beam L1 of different color lights (e.g. red light, green light and blue light) at different time intervals (e.g. TI_R, TI_G and TI_B). To be specific, the light source module 110 includes a plurality of light emitting elements for providing the different color lights at the different time intervals. Each of the color lights is provided from at least one of the plurality of light emitting elements. For example, the light source module 110 provides a red light from red light emitting elements at the time interval TI_R, and next provides a green light from green light emitting elements at the time interval TI_G. For clarity, only the time intervals TI_R and TI_G are shown in FIG. 7, but the disclosure is not limited thereto. The light source module 110 can provide a blue light from blue light emitting elements at a time interval TI_B (not shown). The light source module 120 may include light sources of LEDs, laser diodes, laser phosphors, or a combination thereof.

The light source driver module 120 is coupled to the light source module 110. The light source driver module 120 is configured to drive the light source module 110 to provide the illumination beam L1. The light source driver module 120 includes a plurality of light source drivers. Each of the plurality of light source drivers controls the at least one of the plurality of light emitting elements corresponding to one of the color lights.

The light valve module 130 is configured to receive the illumination beam L1 and convert the illumination beam L1 into a projection beam L2. In the present embodiment, the light valve module 130 includes a plurality of DMDs. The lens module 140 is configured to receive the projection beam L2 and project the projection beam L2 out of the projection device 100 to produce a projected image L3.

The control module 150 is coupled to the light source driver module 120 and the light valve module 130. The control module 150 is configured to generate a first control signal S1 and provide the first control signal S1 to the light source driver module 120. The light source driver module 120 is configured to drive the light source module 110 according to the first control signal S1. The first control signal S1 includes at least one enable signal EN and at least one driving signal PWM. Each of the at least one enable signal EN includes the information of the compensation time period corresponding to one of the color lights. For example, the enable signal EN_G includes the information of the compensation time period Δtabs corresponding to the green light. Since the light source driver module 120 needs to be charged and discharged, it takes a period of time (i.e. delay time Δtabs) for the driving current I to be outputted, and the compensation time period Δtabs is to compensate for this time delay. Each of the at least one driving signal PWM includes the driving current I corresponding to one of the color lights.

One of the plurality of light source drivers receives the at least one enable signal corresponding to one of the color lights and enables the at least one of the plurality of light emitting elements corresponding to the one of the color lights at an enable time point. For example, the light source driver for driving the green light emitting elements receives the enable signal EN_G, and enables the green light emitting elements at the enable time point P1. The enable time point P1 is earlier than a disable time point P2 at a pervious time interval TI_R.

The at least one of the plurality of light emitting elements corresponding to the one of the color lights emits the one of the color lights after the compensation time period from the enable time point. For example, the green light emitting elements emits the green light at a lighting point P3 after the compensation time period Δtabs from the enable time point P1.

The control module 150 obtains a current value Iabs based on a dimming command Sdc, and obtains a compensation time period Δtabs based on the current value Iabs. The dimming command Sdc indicates that a brightness value of the projected image L3 is adjusted to a target brightness value. The first control signal S1 includes information of the current value Iabs and the compensation time period Δtabs. The control module 150 can adjust the enable time period Ten of the enable signal EN_G based on the compensation time period Δtabs. The current value Iabs is greater than respective preset currents for each color light source to be turned on.

To be specific, the control module 150 includes a processor 152 and a control unit 154. The control unit 154 is configured to receive the dimming command Sdc and calculate the current value Iabs corresponding to the target brightness value based on the dimming command Sdc. The control unit 154 obtains the compensation time period Δtabs based on the current value Iabs and transmits a second control signal S2 to the processor 152. The second control signal S2 includes the information of the current value Iabs and the compensation time period Δtabs.

In an embodiment, the control unit 154 includes a storage unit 542. The storage unit 542 is configured to store a look-up table of the current value Iabs and the compensation time period Δtabs corresponding to the current value Iabs. The control unit 154 obtains the compensation time period Δtabs based on the current value Iabs and the look-up table. In other embodiment, the control unit 154 includes a calculation unit 544. The calculation unit 544 calculates the compensation time period Δtabs corresponding to the current value Iabs based on a related curve of the current value Iabs and the compensation time period Δtabs, as shown in FIG. 8. In other embodiment, the control unit 154 includes both the storage unit 542 and the calculation unit 544 to obtain the compensation time period Δtabs based on the look-up table and calculating.

FIG. 8 is a schematic diagram illustrating a related curve of the compensation time period Δtabs (i.e. delay time) and the driving current according to an embodiment of the disclosure. Referring to FIG. 8, FIG. 8 shows the related curve 800 of the current value Iabs and the compensation time period Δtabs, wherein the compensation time period Δtabs is equivalent to the delay time that the light source driver module 120 output the current value Iabs due to charge and discharge. Since the delay time increases as the current value Iabs becomes smaller, the compensation time period Δtabs increases as the current value Iabs becomes smaller.

Specifically, the compensation time period Δtabs is negatively correlated with the current value Iabs (i.e. the driving current). In the embodiment, the related curve 800 of the compensation time period Δtabs and the current value Iabs may be a linear or polynomial equation. By measuring the delay time under different current values and performing curve fitting, the related curve 800 of the compensation time period Δtabs and the current value Iabs may be obtained. Subsequently, based on the related curve 800, a look-up table corresponding to the compensation time period Δtabs required under different driving currents (i.e. current value Iabs) may be established. Therefore, the lower the driving current, the greater the (negative) slope. In addition, the related curve of each color light may be different, so the compensation time period may be different. Besides, different drivers also have different related curves.

Returning to FIG. 7, the processor 152 generates at least one enable signal EN based on the information of the compensation time period Δtabs of the second control signal S2. The processor 152 is coupled to the light valve module 130. The processor 152 is configured to generate and transmit a third control signal S3 to the light valve module 130 to control an operation of the light valve module 130.

In one embodiment, the projection device 100 further includes a scaler 160. The scaler 160 is coupled to the control unit 154. The scaler 160 is configured to generate the dimming command Sdc based on an input signal Sin. The input signal Sin indicates that the brightness value of the projected image L3 is adjusted to the target brightness value. Specifically, the input signal Sin comes from the user's operation, and the dimming command Sdc can be generated in response to the user's operation.

Regarding hardware structures of the components in the embodiment of FIG. 1, the processor 152 and the control unit 154 may be processors having computational capability. Alternatively, the processor 152 and the control unit 154 may be designed through hardware description languages (HDL) or any other design methods for digital circuits familiar to people skilled in the art and may be hardware circuits implemented through a field programmable gate array (FPGA), a complex programmable logic device (CPLD), or an application-specific integrated circuit (ASIC). In addition, the scaler 160 may include an analog front end IC.

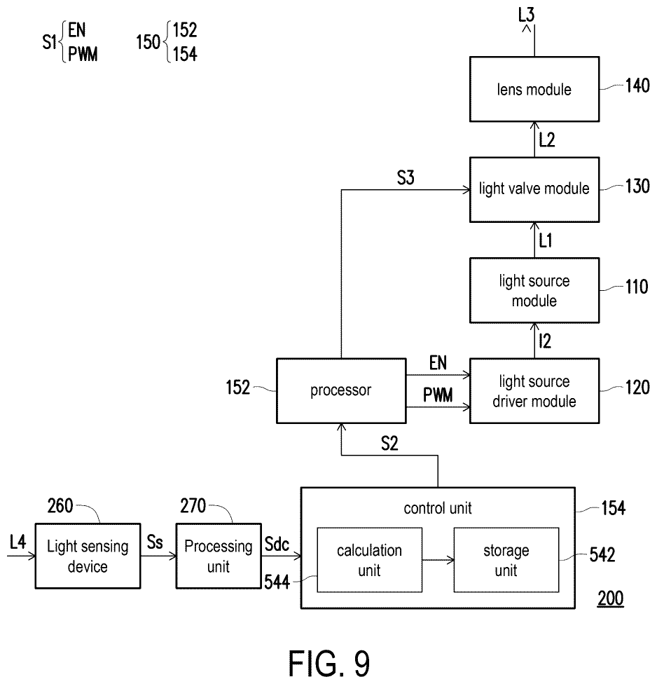

FIG. 9 is a block diagram illustrating a projection device according to another embodiment of the disclosure. Referring to FIG. 1 and FIG. 9, the projection device 200 of FIG. 9 is similar to the projection device 100 of FIG. 1, and the main difference therebetween, for example, lies in that the projection device 200 includes a light sensing device 260 and a processing unit 270. The processing unit 270 is coupled to the light sensing device 260 and the control unit 154 of the control module 150. The light sensing device 260 is configured to sense an environment light L4 and generate a sensing signal Ss. The processing unit 270 is configured to receive the sensing signal Ss, generate the dimming command Sdc based on the sensing signal Ss, and transmit the dimming command Sdc to the control unit 154 of the control module 150.

In summary, in the embodiments of the disclosure, when the user adjusts the brightness of the projected image L3 of the projection device 100 or 200 through the user interface (UI) or knows that the brightness of the projected image L3 needs to be adjusted through the light sensing device 260, the dimming command Sdc is provided to the control unit 154 through the scaler 160 or the processing unit 270. The control unit 154 may calculate the driving current (i.e. current value Iabs) required for each time interval of color lights in the corresponding brightness based on the dimming command Sdc, and obtain the compensation time period Δtabs corresponding to the current value Iabs. After obtaining the compensation time period Δtabs, the control unit 154 provides the second control signal S2 including the information of the current value Iabs and the compensation time period Δtabs to the processor 152, so that the processor 152 outputs the first control signal S1 (i.e. enable signal EN and driving signal PWM) and the third control signal S3, in order to control the light source driver module 120 and light valve module 130, respectively.

In the embodiments of FIG. 1 and FIG. 9, the processor 152 is integrated with the control unit 154 to form the control module 150, but the disclosure is not limited thereto. In another embodiment, the processor 152 can also calculate the current value Iabs and the compensation time period Δtabs, the entire architecture of FIG. 1 and FIG. 9 may be simplified to receive the dimming command Sdc from the scaler 160 through the processor 152 or receive the dimming command Sdc from the processing unit 270. Next, after the processor 152 calculates the current value Iabs and the compensation time period Δtabs, the processor 152 provides the first control signal S1 to the light source driver module 120.

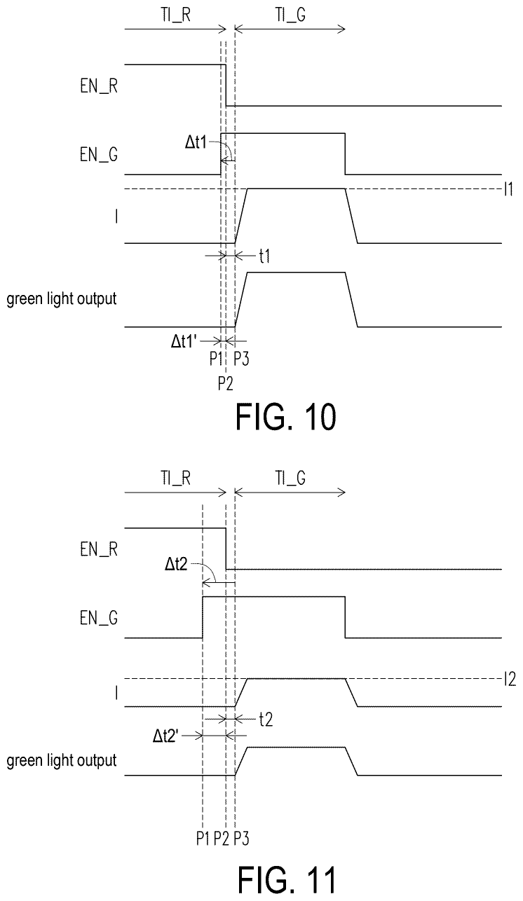

FIG. 10 is a waveform diagram illustrating enable signals and a driving current according to another embodiment of the disclosure. Referring to FIG. 10, in the embodiment, the current value of the driving current is I1, and the compensation time period is Δt1. The time point P1 at which the processor 152 outputs the enable signal EN_G is moved earlier by the compensation time period Δt1. It may be defined that Δt1′ is the time difference between the high level of the enable signal EN_G (i.e. time point P1) and the previous time interval TI_R being turned off (i.e. time point P2), t1 is the period between adjacent time intervals (i.e. time point P3−time point P2), and Δt1′=Δt1−t1.

FIG. 11 is a waveform diagram illustrating enable signals and a driving current according to another embodiment of the disclosure. Referring to FIG. 11, in the embodiment, the current value of the driving current decreases from I1 to I2 (where I2<I1), the compensation time period is extended from Δt1 to Δt2. The time point P1 at which the processor 152 outputs the enable signal EN_G is moved earlier by the compensation time period Δt2. It may be defined that Δt2′ is the time difference between the high level of the enable signal EN_G (i.e. time point P1) and the previous time interval TI_R being turned off (i.e. time point P2), t2 is the period between adjacent time intervals (i.e. time point P3−time point P2), and Δt2′=Δt2−t2. Since the period between adjacent time intervals (i.e. t1 and t2) does not change with the current value of the driving current, the time difference (i.e. Δt1′ and Δt2′) between the time point P1 and the time point P2 changes with the current value of the driving current. That is, the time difference (i.e. Δt1′ and Δt2′) between the time point P1 and the time point P2 increases as the current value becomes smaller.

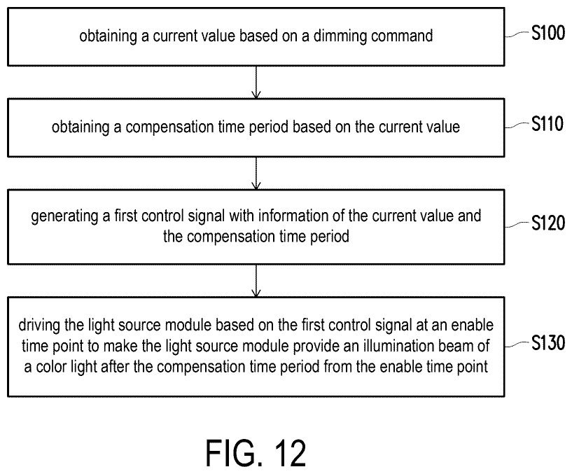

FIG. 12 is a flowchart illustrating steps in a driving method of a light source module suitable for a projection device according to an embodiment of the disclosure. Referring to FIG. 1 and FIG. 12, the driving method of the light source module is at least suitable for the projection device 100 depicted in FIG. 1, but the disclosure is not limited thereto. Taking the projection device 100 for example, in step S100, the control module 150 obtains a current value Iabs based on a dimming command Sdc. In step S110, the control module 150 obtains a compensation time period Δtabs based on the current value Iabs. In step S120, the control module 150 generates a first control signal S1 with information of the current value Iabs and the compensation time period Δtabs. In step S130, the control module 150 drives the light source module 110 based on the first control signal S1 at an enable time point P1 to make the light source module 110 provide an illumination beam L1 of a color light after the compensation time period Δtabs from the enable time point P1.

The driving method of the light source module suitable for the projection device described in the embodiment of the disclosure is sufficiently taught, suggested, and embodied in the embodiments illustrated in FIG. 1 to FIG. 11, and therefore no further description is provided herein.

In summary, in the embodiments of the disclosure, the enable time point at which the processor outputs the enable signal is dynamically adjusted based on the current value provided to the light source module. The projection device can dynamically change the enable time based on brightness adjustment. Therefore, the projection device can have smooth grayscale performance when operating at a low driving current.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims

What is claimed is:

1. A projection device, comprising:
a light source module, configured to provide an illumination beam of different color lights at different time intervals;
a light source driver module, coupled to the light source module, the light source driver module configured to drive the light source module to provide the illumination beam;
a light valve module, configured to receive the illumination beam and convert the illumination beam into a projection beam;
a lens module, configured to receive the projection beam and project the projection beam out of the projection device to produce a projected image; and
a control module, coupled to the light source driver module, the control module configured to generate a first control signal and provide the first control signal to the light source driver module, the light source driver module configured to drive the light source module according to the first control signal,
wherein the control module obtains a current value based on a dimming command, and obtains a compensation time period based on the current value, wherein the dimming command indicates that a brightness value of the projected image is adjusted to a target brightness value,
wherein the first control signal comprises information of the current value and the compensation time period.

2. The projection device according to claim 1, wherein the light source module comprises a plurality of light emitting elements for providing the different color lights at the different time intervals, and each of the color lights is provided from at least one of the plurality of light emitting elements.

3. The projection device according to claim 2, wherein the light source driver module comprises a plurality of light source drivers, and each of the plurality of light source drivers controls the at least one of the plurality of light emitting elements corresponding to one of the color lights.

4. The projection device according to claim 3, wherein the first control signal comprises at least one enable signal, each of the at least one enable signal comprises the information of the compensation time period corresponding to one of the color lights, one of the plurality of light source drivers receives the at least one enable signal corresponding to one of the color lights and enables the at least one of the plurality of light emitting elements corresponding to the one of the color lights at an enable time point, and the at least one of the plurality of light emitting elements corresponding to the one of the color lights emits the one of the color lights after the compensation time period from the enable time point.

5. The projection device according to claim 4, wherein the enable time point is earlier than a disable time point at a pervious time interval.

6. The projection device according to claim 4, wherein a time difference between the enable time point and the disable time point at the pervious time interval increases as the current value becomes smaller.

7. The projection device according to claim 1, wherein the compensation time period increases as the current value becomes smaller.

8. The projection device according to claim 1, wherein the control module comprises a processor and a control unit, the control unit is configured to receive the dimming command and calculate the current value corresponding to the target brightness value based on the dimming command, the control unit obtains the compensation time period based on the current value and transmits a second control signal to the processor, wherein the second control signal comprises the information of the current value and the compensation time period.

9. The projection device according to claim 8, wherein the first control signal comprises at least one enable signal, the processor generates at least one enable signal based on the information of the compensation time period of the second control signal.

10. The projection device according to claim 8, wherein the processor is coupled to the light valve module, the processor is configured to generate and transmit a third control signal to the light valve module to control an operation of the light valve module.

11. The projection device according to claim 1, wherein the control module comprises a storage unit configured to store a look-up table of the current value and the compensation time period, and the control module obtains the compensation time period based on the current value and the look-up table.

12. The projection device according to claim 1, wherein the control module calculates the compensation time period corresponding to the current value based on a related curve of the current value and the compensation time period.

13. The projection device according to claim 1, wherein the control module adjusts an enable time period of the enable signal based on the compensation time period.

14. The projection device according to claim 1, further comprising:
a scaler, coupled to the control module, the scaler is configured to generate the dimming command based on an input signal, wherein the input signal indicates that the brightness value of the projected image is adjusted to the target brightness value.

15. The projection device according to claim 1, further comprising:
a light sensing device, configured to sense an environment light and generate a sensing signal;
a processing unit, coupled to the light sensing device and the control module, the processing unit configured to receive the sensing signal, generate the dimming command based on the sensing signal, and transmit the dimming command to the control module.

16. A driving method of a light source module suitable for a projection device, comprising:
obtaining a current value based on a dimming command, wherein the dimming command indicates that a brightness value of a projected image is adjusted to a target brightness value;
obtaining a compensation time period based on the current value;
generating a first control signal with information of the current value and the compensation time period; and
driving the light source module based on the first control signal at an enable time point to make the light source module provide an illumination beam of a color light after the compensation time period from the enable time point.
